(19) United States
(12) Patent Application Publication
(10) Pub. No.: US 2016/0195382 A1
(43) Pub. Date: Jul. 7, 2016

(54) A MEASUREMENT METHOD

(71) Applicant: RENISHAW PLC, Wotton-under-Edge, Gloucestershire (GB)

(72) Inventors: David Roberts MCMURTRY, Stancombe (GB); Derek MARSHALL, Hawkesbury Upton (GB)

(73) Assignee: RENISHAW PLC, Wotton-under-Edge, Gloucestershire (GB)

(21) Appl. No.: 14/915,737

(22) PCT Filed: Sep. 15, 2014
(86) PCT No.: PCT/GB2014/052793

§ 371 Date: Mar. 1, 2016

(30) Foreign Application Priority Data
Sep. 13, 2013 (GB) 1316329.0

(51) Int. Cl. G01B 5/012

(52) U.S. Cl. CPC G01B 5/012

(57) ABSTRACT

A method is described for using coordinate positioning apparatus, such as a machine tool, to measure an object. The method includes the step of operating the coordinate positioning apparatus in a touch trigger mode to measure the position of one or more touch trigger measurement points on the surface of the object. The coordinate positioning apparatus is also operated in a scanning mode to measure the position of a plurality of scanned measurement points along a scan path on the surface of the object, the scanning mode measurements being acquired using a scanning probe having an object-contacting stylus. At least one correction (Δi;V,R;Δr) is then calculated that describes a difference between the touch trigger mode measurements and the scanning mode measurements. In this manner, touch trigger measurements are used to correct scanning measurements.

The present invention relates to measuring an object using coordinate positioning apparatus comprising a scanning probe, in particular the invention relates to a method of measuring objects using touch trigger mode and scanning mode measurements.

A variety of measurement probes are known that can be used with coordinate positioning apparatus, such as machine tools, coordinate measuring machines or industrial robots. Contact measurement probes typically comprise a probe housing, a stylus that can be deflected relative to the probe housing and a sensor or sensors for measuring stylus deflection.

Touch trigger probes, which are sometimes termed digital probes, are one known type of measurement probe. A touch trigger probe simply acts as a switch and deflection of the stylus from a rest position (e.g. when the stylus tip is moved into contact with the surface of an object) causes a trigger signal to be issued. The coordinate measuring apparatus measures the position of the touch trigger probe in the machine coordinate system (x,y,z) at the instant the trigger signal is issued, thereby allowing (with suitable calibration) the position of a point on the surface of the object to be measured. A touch trigger probe is thus repeatedly driven into, and out of, contact with the surface of an object to take point-by-point position measurements of an object.

Scanning probes, which are commonly termed analogue probes, are another type of measurement probe. A typical analogue probe includes a deflection sensor that can measure both the magnitude and direction of any stylus deflection. For example, the analogue measurement probe may generate three output signals that relate to the deflection of the stylus tip in three mutually orthogonal directions. This allows the position of the stylus tip to be continuously measured relative to the probe housing, for example in a local or probe (a,b,c) coordinate system. Combining the measured stylus tip position (a,b,c,) with the known position of the scanning probe within the machine coordinate system (x,y,z) allows the position of the stylus tip to be measured as it is moved or scanned along a path on the surface of an object. In this manner, a very large number of points on the surface of the object can be measured.

Touch trigger probes have the advantage that they can provide high accuracy touch trigger mode measurements, but having to repeatedly bring the probe into and out of contact with the surface of the object being measured is a relatively slow process. Scanning probes allows many scanning mode measurement points to be collected as the probe is driven along a path on the surface of an object, but the accuracy of each point is typically lower than can be achieved using a touch trigger mode measurement. The cost and complexity of scanning probes, especially when designed to provide high accuracy measurements in a harsh machine tool environment, can also be prohibitive.

According to a first aspect of the present invention, there is provided a method of using coordinate positioning apparatus to measure an object, the method comprising the steps, in any suitable order, of
a) operating the coordinate positioning apparatus in a touch trigger mode to measure the position of one or more touch trigger measurement points on the surface of the object,
b) operating the coordinate positioning apparatus in a scanning mode to measure the position of a plurality of scanned measurement points along a scan path on the surface of the object, the scanning mode measurements being acquired using a scanning probe having an object-contacting stylus, and
c) calculating at least one correction that describes a difference between the touch trigger mode measurements of step (a) and the scanning mode measurements of step (b).

The present invention thus comprises a method of measuring an object using coordinate positioning apparatus operating in both a touch trigger mode and a scanning mode. In particular, one or more touch trigger measurement points on the surface of the object are acquired using the coordinate positioning apparatus in touch trigger mode and a plurality of scanned measurement points are also acquired using the coordinate positioning apparatus in scanning mode by moving the object-contacting stylus of the scanning probe along a scan path on the surface of the object.

In touch trigger mode, the coordinate positioning apparatus uses a measurement probe to acquire one or more touch trigger measurement points on the surface of the object. As explained above, a touch trigger measurement point is acquired by moving the measurement probe towards the surface of an object until a certain spatial relationship with a point on the surface of the object is attained. In the case of a contact touch trigger measurement probe having a deflectable stylus, the measurement process comprising moving the measurement probe towards the surface until contact between the stylus and the object causes a detectable deflection of the stylus. A trigger signal is then issued by the measurement probe to indicate contact with the surface has been made. The position of the measurement probe within the coordinate positioning apparatus at the instant the trigger signal is issued allows, with suitable calibration, the position of the point on the surface of the object (i.e. the touch trigger measurement point) that was contacted by the stylus to be calculated. A plurality of such touch trigger measurement points may be acquired by repeatedly moving the stylus into contact with different points on the surface of the object.

In scanning mode, the coordinate positioning apparatus uses a scanning probe having an object-contacting stylus to measure a plurality of points along a scan path on the surface of the object. In other words, the tip of the stylus of the scanning probe is brought into contact with the object and then moved (e.g. pushed or dragged) along a path on the surface of the object. Scanned measurement points are collected as the path on the surface of the object is traversed. The object measured in scanning mode is the same object measured in touch trigger mode. Furthermore, the object is preferably not moved between taking the scanning and touch trigger mode measurements; e.g. the object may remain secured in the same fixture or clamp of the coordinate positioning apparatus whilst the scanning and touch trigger mode measurements are acquired. It should also be noted that the touch trigger mode measurements and the scanning mode measurements may be acquired in any suitable order; e.g. the touch trigger mode measurements or the scanning mode measurements may be taken first.

After measuring the object in both touch trigger mode and scanning mode, a step (c) is performed that comprises calculating at least one correction that describes a difference between the touch trigger mode and scanning mode measurements. The at least one correction thus describes any variation between the measurements taken in touch trigger mode and scanning mode. As explained below, the at least one correction may comprise an error map or function that describes differences between position measurements taken in touch trigger mode and scanning mode on a point-by-point basis. Alternatively, the at least one correction may describe the difference in a measured position and/or orientation of the object within the coordinate system of the coordinate positioning apparatus or the difference in a measured geometrical property of a feature of an object (e.g. the measured radius of a bore formed in the object) determined from position measurements taken in touch trigger mode and scanning mode.

Touch trigger mode measurements typically have a greater positional accuracy than scanning mode measurements. Although scanning mode measurements may be less accurate, they are typically repeatable. The at least one correction calculated in step (c) can thus be used to correct scanning mode measurements. For example, the at least one correction may be used to correct subsequent scanning mode measurements of the same object and/or scanning mode measurements of further objects that are nominally identical to the object. In this manner, the accuracy of scanning mode measurements may be improved whilst maintaining the advantages of high speed measurement associated with scanning mode operation.

Advantageously, the scan path of step (b) is arranged to nominally pass through the one or more touch trigger measurement points. In this manner, the same or very closely located points on the surface of the object may be measured in both touch trigger mode and scanning mode. The at least one correction may thus conveniently describe positional deviations between scanned measurement points and touch trigger measurement points.

Conveniently, the method comprises the step of using the at least one correction of step (c) to correct the measurements of step (b). As explained in more detail below, step (c) may comprise comparing a small number of accurate touch trigger measurement points acquired during step (a) to some of the scanning measurement points acquired in step (b) to generate the at least one correction. The correction(s) calculated in step (c) may then be applied to all of the scanning measurements points of step (b). In this manner, a high density of improved accuracy measurement points may be generated from the measurements of step (b) using the at least one correction determined in step (c).

The method may be used for measuring a single object. Advantageously, the method is applied to an object that is a first object in a series of nominally identical objects. For example, the object may be one part made in a production run that aims to produce a series of nominally identical parts. The method may then comprise the step of operating the coordinate positioning apparatus in scanning mode to measure one or more further objects in the series of objects. The at least one correction calculated in step (c) may then be applied to the scanning mode measurements of each of the one or more further objects.

The at least one correction may describe differences between the touch trigger mode and scanning mode measurements in any suitable manner. For example, the at least one correction may describe one or more positional deviations between scanned measurement points and touch trigger measurement points. Conveniently, the at least one correction comprises an error map or function that defines the differences in position of the scanned measurement points acquired in step (b) and corresponding touch trigger measurement points acquired in step (a). The at least one correction may thus be used to correct the positions of some or all of the plurality of scanned measurement points to correspond to the touch trigger measurement points.

The at least one correction may directly define positional deviations between scanned and touch trigger measurement points, as described above. Alternatively, the correction may describe a difference between a property of the object derived from the touch trigger measurement points and a corresponding property of the object derived from the scanning measurement points.

Advantageously, step (a) comprises using the one or more touch trigger measurement points to determine at least one of the position and orientation of the object in the coordinate system of the coordinate positioning apparatus. Measurement of the position and/or orientation of the object in touch trigger mode may be used as a setup or datuming step on a machine tool prior to cutting the object. As mentioned above, the acquisition of touch trigger measurements is relatively slow compared with scanning mode measurements; e.g. it may take 20-30 seconds to acquire enough tough trigger points to establish the position and orientation of an object within the machine coordinate system.

Step (b) may then comprise using the scanned measurement points to determine at least one of the position and orientation of the object in the coordinate system of the coordinate positioning apparatus. In other words, the same position and/or orientation of the object can be found using the scanning mode measurements. Although the scanning mode measurement process is repeatable and faster than touch trigger mode measurements (e.g. a scanning mode measurement scan may take under 10 seconds), the scanned measurement points are likely to have a lower accuracy. The position/orientation information derived from such scan mode measurements is therefore likely to differ from (e.g. be less accurate than) the touch trigger mode position and orientation information.

Step (c) may thus conveniently comprise calculating at least one correction that defines a difference between the at least one of the position and orientation as determined in step (a) and the at least one of position and orientation determined in step (b). The at least one correction may thus comprise a vector or offset value that describes the difference in position and/or orientation of the object derived from the touch trigger mode and scanning mode measurements. As outlined above, this correction (e.g. the vector or offset value) may be applied to scanning mode measurements of further objects that are nominally identical to the first object that was used to establish the correction. This allows the position and/or orientation of further objects to be established using the faster scanning mode measurements, but with an accuracy (after correction) approaching that which can be obtained using touch trigger mode measurements.

The present invention can also be applied to measuring the geometrical properties of features of an object. Conveniently, step (a) comprises using the one or more touch trigger measurement points (or more preferably a plurality of such touch trigger measurement points) to determine at least a first reference geometrical property associated with one or more features of the object. The first reference geometrical property may comprise, for example, a geometrical property associated with a single feature (e.g. the diameter or roundness of a cylindrical bore) or a geometrical property that describes the relationship between a plurality of features (e.g. the angularity, parallelism or squareness of two features, such as surfaces). Step (b) may then comprise using the scanned measurement points to determine at least a first scanned geometrical property associated with the one or more features of the object, the first scanned geometrical property corresponding to the first reference geometrical property.

Steps (a) and (b) may then be followed by a step (c) that comprises calculating at least one correction that defines a difference between the first reference geometrical property and the first scanned geometrical property. This may comprise, for example, comparing the first scanned geometrical property with the corresponding first reference geometrical property (i.e. the same geometrical property derived from touch trigger mode and scanning mode measurements is compared) to obtain a first property correction value. It should again be noted that such a first property correction value describes a difference in the measured geometrical property or properties of an object and not the deviation in the position of individual scanned and touch trigger measurement points on the surface of the object.

As outlined above, the method of the present invention may comprise using the coordinate positioning apparatus to measure one or more features of one or more further objects in a series of nominally identical objects. For each further object, scanning mode measurements may be taken that allow a further measured geometrical property to be determined, each further measured geometrical property also corresponding to the first reference geometrical property. The method may then comprise a step of applying the first property correction value to each further measured geometrical property. In other words, a corrected geometrical property may be produced for each further object in the series using the first property correction value. A feature comparison and correction technique has been described previously by the present Applicant in WO2011/107729, the contents of which are hereby incorporated by reference.

The method of the present invention may be implemented using a coordinate positioning apparatus that comprises a scanning probe and a separate touch trigger probe. The different probes may be interchangeably attached to the quill or spindle of the coordinate positioning apparatus to enable operation in touch trigger mode or scanning mode as and when required. Alternatively, the scanning probe of the coordinate positioning apparatus may be a dual mode probe that is operable in both a scanning mode and a touch trigger mode. In a preferred embodiment, the dual mode probe generates a touch trigger mode output (e.g. a trigger signal that changes state when the stylus is deflected) and a separate scanning mode output (e.g. one or more signals that indicate the magnitude and optionally the direction of stylus deflection). Alternatively, deflection measurements acquired by the probe may be processed in an associated controller or interface connected to the probe to provide the touch trigger output. The dual mode probe may include a scanning sensor for measuring the magnitude (and optionally the direction) of stylus deflection. The dual mode probe may use the scanning sensor, or a separate sensor, for sensing stylus deflection when operating in touch trigger mode. A measurement probe of the type described in U.S. Pat. No. 7,086,170 may conveniently be used.

The scanning probe may comprise a sensor that allows the magnitude and direction of stylus deflection to be measured. For example, three probe outputs may describe deflection in three mutually orthogonal directions (x, y and z). Alternatively, deflection in two orthogonal directions (e.g. x and y) may be output by the probe.

In one embodiment, the scanning mode measurements may be acquired using a scanning probe that comprises a multidirectional, single output scanning probe. The multidirectional, single output scanning probe may comprise a probe housing and a deflection sensor. The stylus may be deflectable relative to the probe housing. Advantageously, the stylus may be deflected relative to the probe housing in any of two mutually perpendicular directions or in any of three mutually perpendicular directions. The deflection sensor may generate a single output value that is indicative of only the magnitude of stylus deflection from a rest position. Further preferred aspect of such a probe are described below.

Examples of such measurement probes are the TC76-Digilog and TC64-Digilog probes sold by Blum Novotest GmbH, Germany. The Digilog probes are scanning probes in the sense that they measure the amount of stylus deflection, but they include a measurement sensor that only allows the magnitude of stylus deflection (not the direction of stylus deflection) to be measured. These probes are thus multidirectional (i.e. the stylus tip can be deflected in multiple directions) but they provide only a single output that relates to the magnitude (not direction) of stylus deflection. The Blum Digilog probes TC76-Digilog and TC64-Digilog are thus examples of multidirectional, single output scanning probes. Another example of such a multidirectional, single output scanning probe is the G25 probe sold by Marposs, Italy. To date, such probes have only been used for tolerance checking or applications requiring only low measurement accuracy. However, the present invention makes it possible to use such probes for higher accuracy measurement tasks.

If a multidirectional, single output scanning probe is used, the measurement points of step (b) may be calculated by combining the single output of the scanning probe that is related to the magnitude of stylus deflection with measured or assumed machine coordinates describing the position of the multidirectional, single output scanning probe in the machine coordinate system. The calculation of each scanned measurement point may then use an assumed direction of stylus deflection.

The coordinate positioning apparatus preferably comprises a machine tool. The machine tool may also comprise one or more cutting tools for removing (cutting) material from the object. Any of the preferred or essential features of the second, third, fourth or fifth aspects of the invention that are described below may be applied to the first aspect of the invention.

According to a second aspect of the invention, there is provided a method of measuring an object using coordinate positioning apparatus that comprises a multidirectional, single output scanning probe, the method comprising the steps, in any suitable order, of
a) determining the position of one or more reference points on the surface of the object in a machine coordinate system of the coordinate positioning apparatus,
b) using the multidirectional, single output scanning probe to measure the position of multiple measurement points along a scan path on the surface of the object, the scan path being arranged to pass through or near the one or more reference points,
c) calculating at least one correction from a difference in position of each reference point and a corresponding measurement point.

The second aspect of the present invention thus provides an improved method of measuring an object using a multidirectional, single output scanning probe. In step (a), one or more reference points on the surface of the object are determined. This may, for example, comprise taking touch trigger measurements of the object in a known manner. Step (b) involves performing a scan along a scan path on the surface of the object using the multidirectional, single output scanning probe. Multiple (e.g. many hundreds or thousands) of measurement points along this path may then be collected. The scan path is arranged to pass through or near the one or more reference points of step (a). In step (c), the difference in position between the reference points and the measurement points as measured in steps (a) and (b) is used to generate one or more corrections (e.g. in the form of correction values, error maps or functions etc). These corrections allow the measurement points collected in step (b) to be corrected (e.g. offset or shifted) to take account of drag related factors. It should be noted that step (a) may be performed before or after step (b). Step (c), however, uses the results of steps (a) and (b) and is thus performed after those steps.

Advantageously, the method comprises the additional step (d) of using the at least one correction of step (c) to correct each of the measurement points of step (b) to provide multiple corrected measurement points. In this manner, corrected measurement points are provided that accurately define the surface (i.e. drag related errors are reduced).

Conveniently, the multidirectional, single output scanning probe comprises a probe housing, a stylus that is deflectable relative to the probe housing and a deflection sensor. Preferably, the deflection sensor generates a single output value that is indicative of only the magnitude of stylus deflection from a rest position. This provides, by definition, a single output probe. It should be noted that the single sensor output may be processed to provide multiple signals. Advantageously, the deflection sensor comprises an optical sensor.

The stylus of the multidirectional, single output scanning probe is deflectable in multiple directions (i.e. in more than one direction). Preferably, the stylus is deflectable in two directions or more than two directions. For the avoidance of doubt, a LVDT deflects and senses in a single direction and does not therefore fall within the multidirectional definition. The number of directions of stylus deflection thus exceeds the number of deflection measurement outputs. Preferably, the multidirectional, single output scanning probe is omnidirectional such that the stylus may be deflected relative to the probe housing in any one or more of three mutually perpendicular directions. Advantageously, the multidirectional, single output scanning probe measures only the magnitude (not the direction) of stylus deflection.

Advantageously, the measurement points of step (b) are calculated by combining the single output of the scanning probe that is related to the magnitude of stylus deflection with machine coordinates describing the position of the multidirectional, single output scanning probe in the machine coordinate system. Preferably, the calculation of each measurement point uses an assumed direction of stylus deflection. The at least one correction calculated in step (c) preferably corrects for the difference between the assumed direction of stylus deflection and the actual direction of stylus deflection. The effects of stylus slippage or drag, which is related to the friction between the surface of the object and the stylus tip, can thus be compensated using the at least one correction.

Preferably, a plurality of reference points are distributed along the scan path and a correction is calculated for each reference point. Each correction may be associated with a segment of the scan path. Each correction may then be used to correct all measurement points of its associated segment. The extent of each segment is preferably based on one or more nominal properties of the object being measured. For example, segments may be defined by reference to expected surface properties or surface shape.

Step (a) of the method may comprise using any known technique to measure reference points (i.e. discrete points) on the object. It is preferred the step comprises using the coordinate positioning apparatus for the measurement. Step (a) of the method may thus conveniently comprise measuring the one or more reference points using a touch trigger probe (e.g. a probe different to the multidirectional, single output scanning probe) that is carried by the coordinate positioning apparatus. Preferably, the multidirectional, single output scanning probe can also be operated in a touch trigger mode and step (a) comprises measuring the one or more reference points using the multidirectional, single output scanning probe operated in a touch trigger mode. The touch trigger measurements are preferably taken by driving the probe into the surface of the object along a direction having a known relationship to the surface normal direction. Preferably, the touch trigger measurements are taken by driving the probe into the surface of the object along the surface normal direction. The effects of stylus slippage can thus be avoided in the touch trigger measurements. A Blum digilog probe of the type described above may be conveniently employed. If a touch trigger measurement process is used, an initial step of performing a touch trigger calibration process may be implemented.

The coordinate positioning apparatus may comprise any such apparatus. Preferably, the coordinate positioning apparatus comprises a machine tool.

According to a third aspect of the invention, there is provided a method of measuring an object using coordinate positioning apparatus that comprises a measurement probe, the measurement probe being a multidirectional, single output scanning probe that can be operated in a scanning mode or a touch trigger mode, the method comprising the step of using measurements of the object acquired using the measurement probe in touch trigger mode to correct measurements of the object acquired using the measurement probe in scanning mode. Any of the preferred or essential features of the first or second aspects of the invention may be applied to this third aspect of the invention.

According to a fourth aspect of the invention, there is provided a method of measuring an object using coordinate positioning apparatus that comprises a multidirectional, single output scanning probe having a deflectable stylus, the method comprising the step of calculating the direction of stylus deflection as the stylus is scanned along a path on the surface of an object, wherein the direction of stylus deflection is calculated by comparing the position of one or more points on the object as measured by the multidirectional, single output scanning probe with known positions of those one or more points. Any of the preferred or essential features of the first, second or third aspects of the invention may be applied to this fourth aspect of the invention.

According to a fifth aspect of the invention, there is provided a method of measuring an object using coordinate positioning apparatus comprising a scanning probe, the scanning probe comprising a deflectable stylus and a deflection sensor that generates a single output value indicative of only the magnitude of stylus deflection, the method comprising the steps, in any suitable order, of; a) determining the position of one or more reference points on the surface of the object in a machine coordinate system of the coordinate positioning apparatus, b) using the scanning probe to measure the position of multiple measurement points along a scan path on the surface of the object, the scan path being arranged to pass through or near the one or more reference points, c) calculating at least one correction from a difference in position of each reference point and a corresponding measurement point. Any of the preferred or essential features of the first, second, third or fourth aspects of the invention may be applied to this fifth aspect of the invention.

The present invention also extends to apparatus that is arranged to implement the various methods described herein.

The invention also extends to apparatus configured to implement the methods according to the first, second, third or fourth aspects of the invention.

The invention will now be described, by way of example only, with reference to the accompanying drawings in which;

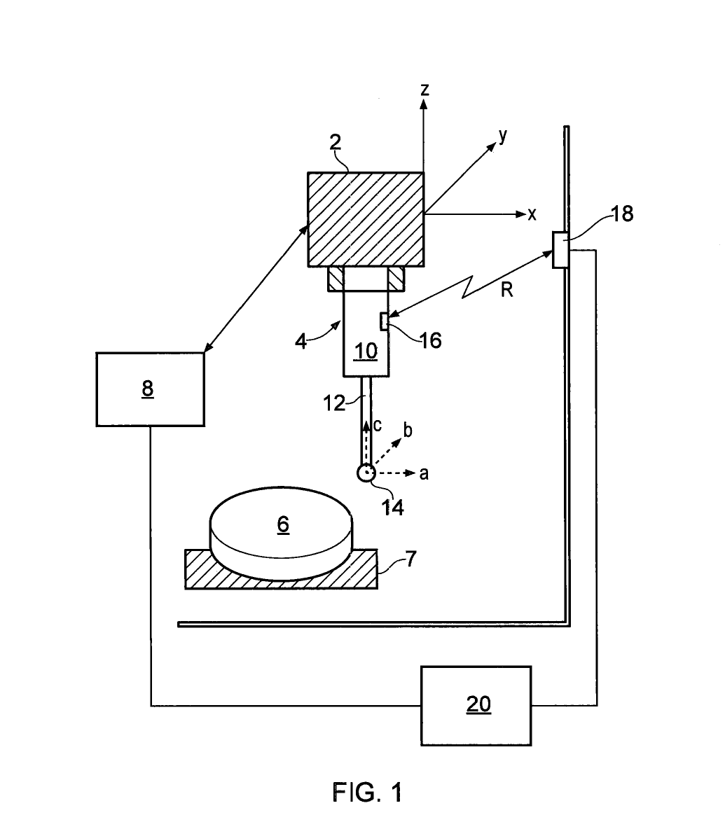

FIG. 1 shows coordinate positioning apparatus comprising a measurement probe,

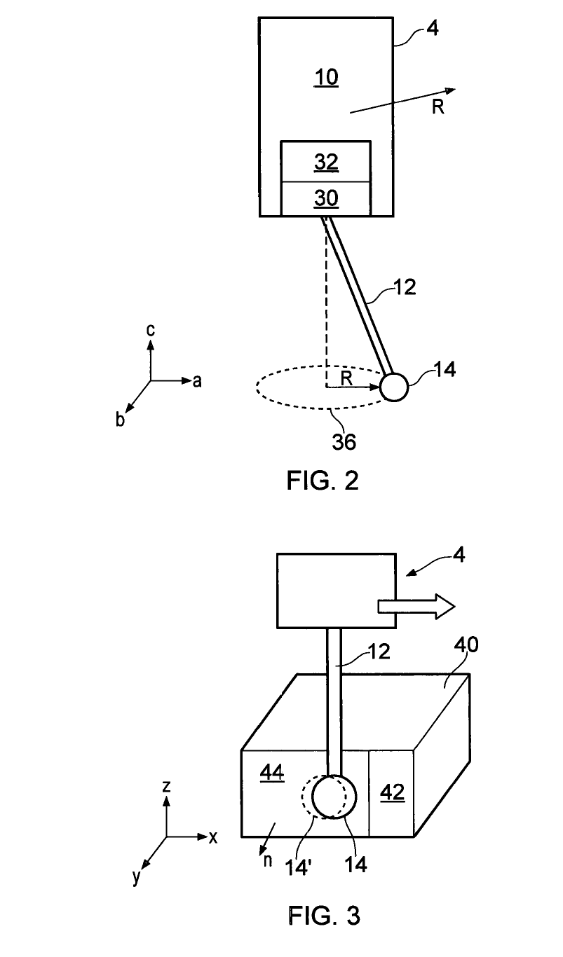

FIG. 2 shows a multidirectional, single output measurement probe,

FIG. 3 illustrates the effect of drag on the direction of stylus deflection,

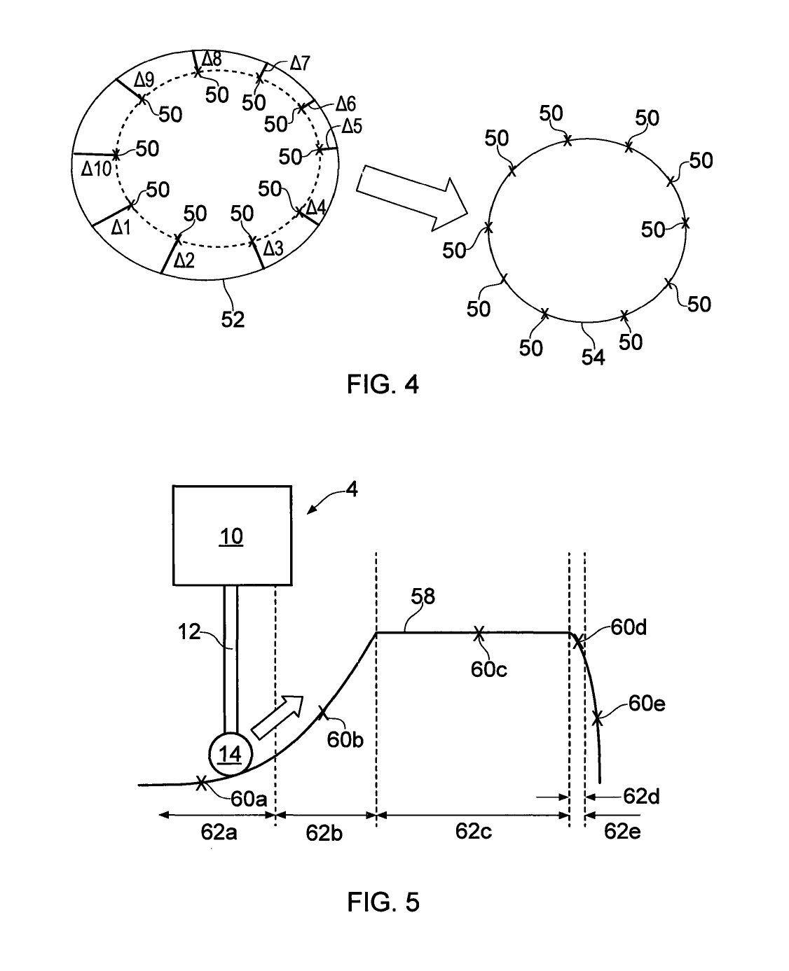

FIG. 4 illustrates reference points and acquired measurement points,

FIG. 5 illustrates how different corrections may be provided for different segments of a scan path,

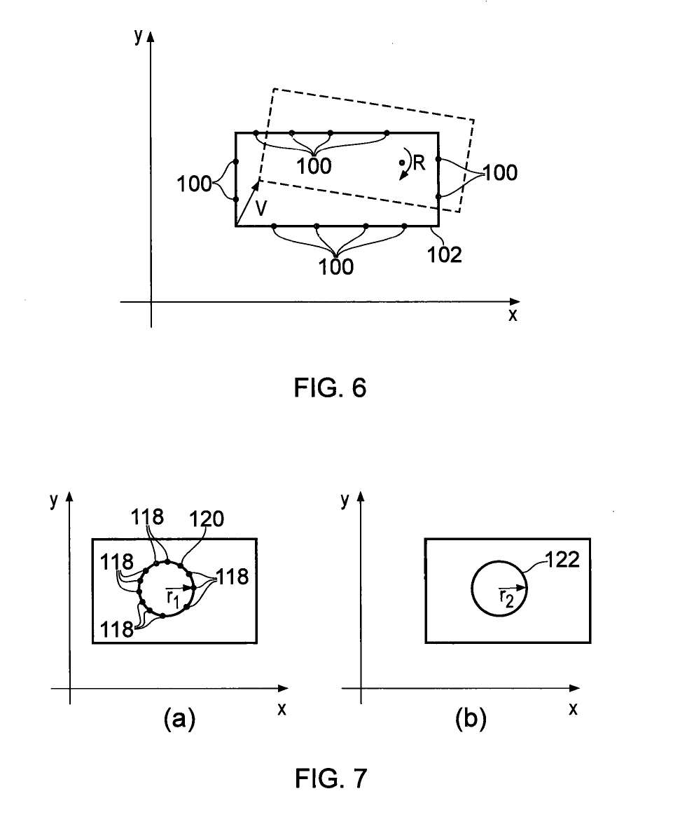

FIG. 6 illustrates providing object setup corrections, and

FIG. 7 illustrates the use of feature correction.

Referring to FIG. 1, a machine tool (which is one example of a coordinate positioning apparatus) is illustrated having a spindle 2 holding an multidirectional, single output scanning probe 4.

The machine tool comprises known means, such as one or more motors (not shown), for moving the spindle 2 relative to a workpiece 6 located on a workpiece holder 7 within the work area of the machine tool. The location of the spindle within the work area of the machine is accurately measured in a known manner using encoders or the like; such measurements provide spindle position data defined in the machine co-ordinate system (x,y,z). A numerical controller (NC) 8 of the machine tool controls movement of the spindle 2 within the work area of the machine tool and also receives feedback relating to spindle position (x,y,z).

The multidirectional, single output scanning probe 4 comprises a probe body or housing 10 that is attached to the spindle 2 of the machine tool using a standard releasable tool shank connection. The probe 4 also comprises a workpiece contacting stylus 12 that protrudes from the housing. A ruby stylus ball 14 is provided at the tip of the stylus 12 for contacting the associated workpiece 6. The stylus tip can deflect relative to the probe housing 10 in any direction (i.e. it is deflectable in any one or more of the a, b or c directions) but the transducer within the probe body 10 generates only a single output signal (R) that has a magnitude related to the magnitude of stylus tip deflection away from the home or rest position.

The probe 4 also comprises a transmitter/receiver portion 16 that communicates with a corresponding receiver/transmitter portion of a remote interface 18. In this manner, probe deflection magnitude data (R) from the probe 4 is output over a wireless communications link. Spindle position data (x,y,z) from the machine tool's NC 8 and probe deflection magnitude data (R) collected by the probe interface 18 are passed to the machine tool's front-end computer 20. The computer 20 is then able to combine the spindle position data (x,y,z) and the probe deflection magnitude data (R).

Referring next to FIG. 2, the multidirectional, single output scanning probe 4 is shown in more detail. As explained above, the probe 4 includes a stylus deflection mechanism 30 that allows the stylus tip to be deflected in any direction relative to the probe housing 10. A transducer 32 is also provided to measure only the amount of stylus deflection. This arrangement means that although the magnitude (R) of stylus deflection can be measured, the single output signal from the transducer does not define the direction of stylus deflection. There is thus ambiguity in where the stylus tip is located based on the transducer 32 output alone. In the example shown in FIG. 2, a stylus tip deflection in the a,b plane will provide the same output value of R if the tip is located anywhere on the circle 36.

Referring next to FIG. 3, consider the example of scanning the tip of the multidirectional, single output scanning probe 4 along the side of an object 40 at a certain scan speed. In the absence of any friction between the stylus tip 14 and the object 40, it could be assumed that the stylus tip 14 is deflected along the surface normal direction n (which is coincident with the machine tool y-axis in this simple example). It would then be possible to make an assumption about the direction of stylus deflection and thereby uniquely calculate the stylus tip position.

However, the inevitable friction between the stylus tip 14 and the object 40, plus variation in the force with which the tip is pressed into engagement with the surface, means that there is a drag effect on the stylus tip 14. This drag causes the direction of stylus tip deflection to shift away from the surface normal direction. For example, the drag may cause the tip to be located in the position 14′ shown in FIG. 3. The amount of drag can't be established from the measurement value R output from the transducer 32; i.e. the drag effect cannot be separated from surface normal deflection variations because there is not enough information from the single output. Furthermore, the friction of the surface of an object may vary. For example, the object 40 may comprise first and second regions 42 and 44 that have different surface properties and hence different coefficients of friction.

The variations in drag that occur along a scan path have previously precluded multidirectional, single output scanning probes from being used in methods of accurately measuring the position of points on the surface of an object.

Referring to FIG. 4, a method will be described that allows objects to be scanned using a multidirectional, single output scanning probe mounted to a machine tool as described above.

An object, such as a block comprising a bore, is firstly measured using the multidirectional, single output scanning probe 4 operating in touch trigger mode. In particular, the probe 4 may be arranged so that the single output R from the transducer 32 is compared to a threshold and a trigger signal is issued when the threshold is exceeded. The trigger signal may then be fed into skip input of the machine tool controller to allow touch trigger operation in a known manner. The probe 4 can thus operate in a touch trigger mode that is equivalent to a conventional touch trigger probe. In particular, the probe 4 can be driven into contact with a plurality of different points around the circumference of the internal surface of the bore. A trigger signal is issued each time the stylus tip makes contact with a point on the surface and the position of the probe 4 in the machine coordinate system (x,y,z) on receipt of the trigger signal is used to provide a touch trigger measurement point. These touch trigger measurement points may be acquired with high accuracy and thus provide a small number of accurate reference points 50 on the surface of the object that are measured in the machine coordinate system. The person skilled in the art would appreciate the necessary calibration steps etc that are required to take such touch trigger measurements.

After acquiring the reference points 50, a drive path is defined that scans the stylus tip 14 around the circumference of the bore. This drive path is selected so that the stylus tip moves along a scan path on the internal surface of the bore, preferably ensuring that contact with the surface is maintained for the whole scan. The scan path is selected to pass through, or near, the reference points 50 that were measured using the touch trigger technique. The output R from the transducer 32 is recorded, along with the x,y,z positions of the measurement probe, as the probe 4 is scanned along the scan path. The magnitude of stylus deflection R is combined with the x,y,z positions of the measurement probe to provide a series of measurement points along the scan path; this combination process relies on an assumption that stylus deflection will be along the surface normal or at a certain angle relative to the surface normal. The result of this process is a large number of measurement points that are illustrated by the solid line 52 in FIG. 4.

As explained above, the assumed stylus deflection direction used to calculate the measurement points during the scanning process is unlikely to be correct and is also likely to vary along the scan path. The error arising from using the assumed stylus deflection direction results in the measurement points acquired during the scan (i.e. the many thousands of measurement points 52 that are shown as a solid line) not coinciding with the reference points 50 derived using the touch trigger measurements. The magnitude of this difference is, for clarity, greatly exaggerated in the drawings.

The present invention comprises comparing the reference points 50 with corresponding measurement points 52 taken when scanning along the scan path. Corrections (Δᵢ) can then be calculated that describe the deviation of the measurement points 52 from the reference points 50. These corrections (Δᵢ) can then be applied to all the measurement points 52 to generate corrected measurement points 54. This process comprises applying each correction (Δᵢ) to multiple measurement points in the vicinity of the respective reference point. The solid line showing the multiple corrected measurement points 54 then passes through the reference points 50. In this manner, it can be seen that the error in the measurement points 52 that arises from assuming a certain stylus deflection direction can be corrected using the corrections (Δᵢ) to provide a large number of corrected measurement points 54 that define the shape of the internal bore.

FIG. 5 illustrates how a similar process may be performed on a differently shaped surface 58. The surface 58 may be divided into differently sized segments 62-62e and a reference point 60a-60e measured using a touch trigger measurement procedure in each segment. The segments may be selected based on the surface profile or surface finish; i.e. the surface may be divided into different segments in which different amounts of stylus drag is likely to occur. The surface 58 may then be scanned to generate multiple measurement points and a correction calculated for each segment using the relevant reference point 60a-60e. The measurement points in each segment may then be corrected using that segment's correction.

FIG. 6 illustrates how a first object's position and orientation within the coordinate system of the machine tool may be found using both touch trigger and scanning mode measurements. In particular, a plurality of touch trigger measurement points 100 of the first object taken in touch trigger mode are shown. Assuming the nominal shape of the first object is known, the touch trigger measurement points 100 allow the position and orientation of the first object to be defined within the machine tool coordinate system. The solid box 102 illustrates the position of the first object as determined from the touch trigger measurement points 100.

The first object may then be scanned using a scanning probe to generate multiple (e.g. many thousands) of scanned measurement points (these are not shown individually in FIG. 6). The scan may be performed by moving the stylus around the first object along a scan path that nominally passes through the touch trigger measurement points 100. The scanned measurement points may then be used to separately establish the position (shown as dashed box 104) of the object.

The difference in position and orientation of the object as measured in touch trigger mode and scanning mode is then calculated. In this example, a vector V describes the positional shift of a corner of the first object and a rotation value R describes the difference in orientation. The difference in position and orientation could, of course, be described in any suitable manner. Although a simple two dimensional example is shown, it should also be noted that this could (and typically would) be performed in three dimensions.

Any difference between the touch trigger mode and scanning mode measurements is likely to arise from errors in the scanning mode measurements. This may, for example, be due to the assumptions made when using a multidirectional, single output scanning probe. The corrections defined by values V and R thus describe the differences between accurate touch trigger mode and less accurate (but repeatable) scanning mode measurements of the first object.

After calculating the corrections (i.e. values V and R), the first object is removed from the machine tool and a further object nominally identical to the first object is placed on the machine tool in nominally the same position as the first object. For example, a fixture used to retain the first object may be used to hold the further object. The further object may then be scanned using the scanning probe in scanning mode. Preferably, the further object is scanned in a similar manner (e.g. using the same scan path, scan speed etc) as the first object. The position and orientation of the further object can then be derived from the collected scanned measurement points. The position and orientation of the further object obtained by analysis of the scanned measurement points can then be corrected using the previously established corrections (i.e. values V and R). In this manner, the position and orientation of the further object is corrected for errors that arise from the scanning probe.

FIG. 7 illustrates how a geometrical property (i.e. radius) of a feature of a first object may be found using both touch trigger and scanning measurements. In particular, a plurality of touch trigger measurement points 118 are taken on the internal surface of a bore of the object. Analysis of these touch trigger measurement points 118 is used to establish (e.g. using a best fit method) a radius r1 of the bore. The same bore of the first object may then be re-measured using a scanning probe operating in scanning mode. For example, the stylus of the scanning probe may be moved in a circular path around the inside of the bore. Analysis of the scanned measurement points (not shown for clarity) may be used (e.g. using a best fit method) to measure a radius r2 of the bore. The difference between radii r1 and r2 thus provides a radius correction factor (Δr).

The first object is then removed from the machine tool and replaced with a further object that is nominally identical to the first object. The further object is then scanned using the scanning probe in scanning mode. Preferably, the further object is scanned in a similar manner (e.g. using the same scan path, scan speed etc) as the first object. The radius r3 of the bore of the further object is established from the scanning mode measurements and then corrected by applying the previously determined radius correction factor (Δr). A corrected radius of the bore of the further object is thus obtained.

Although a simple bore is described, the same approach could be applied to any geometrical property or properties of one or more features of an object. For example, a reference geometrical property may comprise a geometrical property associated with a single feature (e.g. the diameter or roundness of a cylindrical bore) or a geometrical property that describes the relationship between a plurality of features (e.g. the angularity, parallelism or squareness of two features, such as surfaces). Further example of such geometrical properties are described in WO2011/107729.

It should again be remembered that the above examples are illustrative only. Although the above examples describe the use of a multidirectional, single output scanning probe 4 it would be possible to use any type of scanning probe. The scanning probe is preferably a contact scanning probe with a deflectable stylus. The skilled person would appreciate the different ways in which the invention could be implemented. For example, the order of taking measurements (touch trigger followed by scanning) could be reversed. The method could also be implemented on coordinate positioning apparatus other than machines tools, such as dedicated coordinate measuring machines (CMM), robots etc.

1. A method of using coordinate positioning apparatus to measure an object, the method comprising the steps, in any suitable order, of;
a) operating the coordinate positioning apparatus in a touch trigger mode to measure the position of one or more touch trigger measurement points on the surface of the object,
b) operating the coordinate positioning apparatus in a scanning mode to measure the position of a plurality of scanned measurement points along a scan path on the surface of the object, the scanning mode measurements being acquired using a scanning probe having an object-contacting stylus, and
c) calculating at least one correction that describes a difference between the touch trigger mode measurements of step (a) and the scanning mode measurements of step (b).

2. A method according to claim 1, wherein the scan path of step (b) is arranged to nominally pass through the one or more touch trigger measurement points.

3. A method according to claim 1, comprising the additional step of using the at least one correction of step (c) to correct the measurements of step (b).

4. A method according to claim 1, wherein the object measured in steps (a) and (b) is a first object in a series of nominally identical objects, the method comprising the steps of operating the coordinate positioning apparatus in scanning mode to measure one or more further objects in the series of objects and applying the at least one correction calculated in step (c) to the measurements of each of the one or more further objects.

5. A method according to claim 1, wherein the at least one correction comprises an error map or function that defines the differences in position of the scanned measurement points acquired in step (b) and corresponding touch trigger measurement points acquired in step (a).

6. A method according to claim 1, wherein;
step (a) comprises using the one or more touch trigger measurement points to determine at least one of the position and orientation of the object in the coordinate system of the coordinate positioning apparatus,
step (b) comprises using the scanned measurement points to determine at least one of the position and orientation of the object in the coordinate system of the coordinate positioning apparatus, and
step (c) comprises calculating at least one correction that describes a difference between said at least one of the position and orientation as determined in step (a) and said at least one of the position and orientation as determined in step (b).

7. A method according to claim 1, wherein;
step (a) comprises using the one or more touch trigger measurement points to determine at least a first reference geometrical property associated with one or more features of the object,
step (b) comprises using the scanned measurement points to determine at least a first scanned geometrical property associated with the one or more features of the object, the first scanned geometrical property corresponding to the first reference geometrical property, and
step (c) comprises calculating at least one correction that defines a difference between the first reference geometrical property and the first scanned geometrical property.

8. A method according to claim 1, wherein the coordinate positioning apparatus comprises a touch trigger probe.

9. A method according to claim 1, wherein the scanning probe of the coordinate positioning apparatus is a dual mode probe that is operable in both a scanning mode and a touch trigger mode.

10. A method according to claim 9, wherein the scanning probe generates a touch trigger mode output and a separate scanning mode output.

11. A method according to claim 1, wherein the scanning mode measurements are acquired using a scanning probe comprising a multidirectional, single output scanning probe.

12. A method according to claim 11, wherein the multidirectional, single output scanning probe further comprises a probe housing and a deflection sensor, the stylus being deflectable relative to the probe housing and the deflection sensor generating a single output value that is indicative of only the magnitude of stylus deflection from a rest position.

13. A method according to claim 12, wherein the multidirectional, single output scanning probe comprises a stylus that may be deflected relative to the probe housing in at least two mutually perpendicular directions.

14. A method according to claim 13, wherein the scanned measurement points of step (b) are calculated by combining the single output of the scanning probe that is related to the magnitude of stylus deflection with machine coordinates describing the position of the multidirectional, single output scanning probe in the machine coordinate system, wherein the calculation of each scanned measurement point uses an assumed direction of stylus deflection.

15. A method according to claim 1, wherein the coordinate positioning apparatus comprises a machine tool.

16. A method of measuring an object using coordinate positioning apparatus that comprises a multidirectional, single output scanning probe, the method comprising the steps, in any suitable order, of;
a) determining the position of one or more reference points on the surface of the object in a machine coordinate system of the coordinate positioning apparatus,
b) using the multidirectional, single output scanning probe to measure the position of multiple measurement points along a scan path on the surface of the object, the scan path being arranged to pass through or near the one or more reference points,
c) calculating at least one correction from a difference in position of each reference point and a corresponding measurement point.

17. A method according to claim 16, comprising the additional step of (d) using the at least one correction of step (c) to correct each of the measurement points of step (b) to provide multiple corrected measurement points.

18. A method according to claim 16, wherein the multidirectional, single output scanning probe is omnidirectional such that the stylus may be deflected relative to the probe housing in three mutually perpendicular directions.

19. A method of measuring an object using coordinate positioning apparatus that comprises a measurement probe operable in a scanning mode or a touch trigger mode, the method comprising the step of using measurements of the object acquired using the measurement probe in touch trigger mode to correct measurements of the object acquired using the measurement probe in scanning mode.

20. A method according to claim 19, wherein the method comprises using a measurement probe comprising a multidirectional, single output scanning probe.
